(19) United States
(12) Patent Application Publication
(10) Pub. No.: US 2010/0201038 A1
(43) Pub. Date: Aug. 12, 2010

(54) METHOD FOR THE TRANSFER OF STRUCTURAL DATA, AND DEVICE THEREFOR

(75) Inventors: Peter Eckerle, Weinheim (DE); Florian Dötz, Singapore (SG); Udo Lehmann, Bickenbach (DE); Hans-Georg Fercher, Niederkirchen (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/523,640

(22) PCT Filed: Jan. 18, 2008
(86) PCT No.: PCT/EP2008/050531

§ 371 Date: Jan. 22, 2010

(30) Foreign Application Priority Data
Jan. 19, 2007 (EP) 07100822.1

(51) Int. Cl. B29C 35/08

(52) U.S. Cl. 264/400; 264/485; 425/135; 425/174.4

(57) ABSTRACT

The invention relates to a method for transferring structural information into a functional layer, the functional layer being provided on a support layer in a first step. In a second step, energy is transferred locally through the support layer into the functional layer, so as to cause a modification of the physical and/or chemical properties of the functional layer in the region of this zone. The invention furthermore relates to a device for carrying out the method.

The present invention relates to a method for transferring structural information into a functional layer, as well as to a device therefor. Such a method is employed, for example, in semiconductor technology.

At present, essentially two methods for transferring structural information into a functional layer are known. For example, WO 03/080285 discloses a device and a method for the laser structuring of functional polymers. In this context, the term functional polymers means an organic material which fulfills a function in a semiconductor component, for example conduction or non-conduction. For the structuring, pulsed laser light is directed onto a photomask, the mask image being reduced by suitable optics and imaged onto the functional layer to be structured. The pulsed laser light causes laser ablation, so that a corresponding structure is inscribed in the functional layer.

Besides this lithography with laser light, it is also known to carry out the structuring by continuous printing methods, as described for example in DE 100 33 112.

The known laser ablation method, however, has the disadvantage that the ablation detached from the functional layers is ejected into the laser light and therefore prevents further continuous ablation. Continuous use of the laser light is therefore not possible. Furthermore, it is necessary to make sure that the layer to be ablated can absorb the laser light as fully as possible or that it is virtually transparent for the laser, so that an underlying absorption layer can carry out the energy transfer.

The choice of materials for the layer to be ablated is therefore very limited. Particularly when the layer to be ablated is reflective, which is often necessary particularly in semiconductor technology, the laser lithography will be perturbed so that the structures do not have the often required accuracy. It may furthermore be possible that in order to remove reflective layers, the laser power must be increased very greatly, which drives up the costs of the laser ablation method.

In the previous laser ablation techniques which use a mask, a pulsed laser beam is employed. Before the laser beam is focused onto a region on the substrate, it is sent through an optical imaging unit with a mask. The mask represents the pattern to be ablated in an enlarged form. The imaging optics then lead to projection of this mask image on a reduced scale onto the substrate. With such techniques, it is then possible to ablate a small region of for example about 20×20 mm² in one or more pulses. Larger structures, however, cannot be produced in this way.

On the basis of this prior art, it is an object of the present invention to provide a method for transferring structural information into a functional layer, which makes do with a small laser power and can perform the structuring very rapidly, and above all very precisely. The method should furthermore be continuously operable and not present any restriction with respect of the functional layer's area to be processed.

According to the invention, this object is achieved in that the functional layer is provided on a support layer in a first step and energy is transferred in sections through the support layer into the functional layer in a second step, so as to cause a modification of the physical and/or chemical properties of the functional layer in the region of this zone.

The method according to the invention is used, for example, to produce conductive structures, for example conductor tracks on printed circuit boards or electrodes. It is also possible to structure other functional materials with the method according to the invention, for example semiconductors or dielectrics. Besides the production of electronic components, however, it is also possible to use the method for graphical applications in which an image is intended to be produced.

In order to produce electrically conductive structures, electrically conductive materials are preferably used for the functional layer. Such materials are, for example, conductive polymers, preferably polythiophenes or polyanilines. In order to increase the conductivity, further electrically conductive substances may be added to the conductive polymers. These are for example metal powders, carbon nanotubes, zinc oxide etc. It is also possible to include additives which expediently affect the work function of charge carriers, so that these can readily enter the energy bands of an adjacent semiconductor. This may, for example, be done by coating a conductor track serving as an electrode.

Furthermore, it is also possible for example to use an organic semiconductor material or a dielectric for the functional layer. Conductive polymers used for the functional layer are widely available commercially.

The support layer, onto which the functional layer is applied, is preferably made of a material which is transparent for the laser light being used. Suitable supports are in particular plastic sheets, for example PET sheets or polyimide sheets. To promote adhesion and smooth the surface, the support sheet may be provided with a coating.

Instead of a support sheet, it is alternatively also possible to use a rigid support. The rigid support may, for example, be a rigid plate of a transparent plastic or of glass.

Before the structure can be excavated from the functional layer by energy input, it is necessary to apply the functional layer onto the support. The functional layer may be applied onto the support by any coating method known to the person skilled in the art. The material for the functional layer is usually applied onto the support in solution. Any coating method known to the person skilled in the art is suitable for the application. Such coating methods are, for example, standard printing methods. As an alternative, however, it is also possible to apply the material for the functional layer by sublimation. If the stability of the functional layer after the application is insufficient, the functional layer may be cured in order to prevent the structures from becoming blurred. The functional layer is preferably cured thermally or by UV radiation, the preferred method being dictated by the sensitivity of the materials of the functional layer and the requirements for the rate at which the functional layer should be cured. In this case, it should be taken into account that curing by UV radiation is faster but may lead to the destruction of sensitive materials.

The application of the functional layer and optionally drying and curing of the functional layer are preferably carried out in one process operation with the subsequent structuring.

The thickness of the functional layer depends on the type of material of the functional layer. When using conductive polymers, thicknesses of from 200 nm to 1000 nm are preferred. For use as semiconductors, thicknesses of about 100 to 300 um are preferred, and from 100 nm to 10,000 nm for dielectrics.

Owing to the fact that the energy is transferred through the support layer, the functional layer is ablated on the opposite side so that the beam path is not compromised. It is therefore possible to operate the laser beam continuously. The term “modification of the physical and/or chemical properties of the functional layer” not only means partial ablation of the functional layer. Rather, for example, it is also possible to induce a phase transition or a chemical reaction in the functional layer with the aid of the energy transferred through the support layer. What is essential is merely that the functional layer, which is generally smooth and homogeneous before the treatment, is structured in some form after the treatment, i.e. some zones differ in chemical or physical form from other zones.

According to a particularly preferred embodiment, the energy is transferred through the support layer into an absorption layer, which lies between the support layer and the functional layer, and is transferred from the absorption layer into the functional layer. In this case, the laser must merely be adapted to the absorption layer. The transmission and absorption properties of the functional layer are of secondary importance, since the laser beam is already fully absorbed in the absorption layer and the energy is transferred from there into the functional layer (essentially by thermal conduction).

The absorption layer generally contains an absorbent for the laser being used and a binder, by which a uniform film is produced on the support surface. The absorption layer may also contain additives in order to promote adhesion with respect to the support and/or with respect to the functional layer, in order to adjust the viscosity, as a crosslinking agent for the binder or else for coloration. It is also possible for the absorption layer to contain additives which affect the dielectric or conduction properties of the absorption layer. The absorbent employed must be tuned to the laser being used. This applies particularly when using organic or inorganic compounds which absorb specifically in the wavelength range of the laser irradiation. Another suitable absorbent is carbon black, which absorbs rather nonspecific ally over a wide wavelength range. The binder for the absorption layer must be selected so that the absorbent being used remains bound in the binder. Since the absorption layer is usually co-ablated during the structuring by the laser, it is not necessary for the binder to be stable with respect to the laser irradiation. Neighboring regions, however, must not be damaged.

According to a further alternative embodiment, the energy transfer is selected so that the absorption layer, and therefore also the functional layer, is fully removed in sections.

It is possible to fill the resulting recess with another material. The energy is advantageously transferred with the aid of a laser beam, which preferably has a wavelength of between 150 and 3000 nm. In principle, any laser source is suitable for the method according to the invention. It is also unimportant whether a pulsed or continuous-wave laser is used. In order to achieve precise structuring for the functional layer, it is preferable for the power of the laser to be selected so that less than 20 μJ are needed per laser point. In this way, it is possible to use an inexpensive system which allows faster operation than with a higher power. Owing to the low power per laser point, a working frequency up to in the 100 MHz range is possible.

As an alternative to this, the energy may also be transferred with the aid of an electron beam.

In a particularly preferred application of the method according to the invention, the structural information which is transferred into a functional layer is an electronic circuit or part of an electronic circuit.

It is of course also possible for a plurality of separate functional layers to be provided. In this case, each functional layer may even be assigned its own absorption layer, the absorption layers then advantageously having different absorption spectra from one another and the energy being transferred with the aid of laser beams of different wavelengths. In this way, a structure may be introduced into the first functional layer with the aid of a laser beam having a fixed wavelength, while in a further simultaneous or separate working step a structure is introduced into the second functional layer by a laser beam with a wavelength different therefrom.

According to another preferred embodiment, the energy is transferred without a mask, and specifically by using a continuous-wave laser beam which is imaged onto the desired area with the aid of suitable optics.

The entire method according to the invention may be carried out continuously as a roll-to-roll method. In this case, a band transparent for the laser beam is used as the layer support, which is coated first with the absorption layer and then with the functional layer in a continuous process. After the coating, the band may be structured with the aid of a laser beam during its movement through the coating mechanism. In this way, on the one hand it is possible to coat the band in a first working step and then wind it onto a roll. The coated, wound band may optionally be stored temporarily. For the structuring, the coated band is fed to a functional unit in which the structuring takes place in a second working step. It is, however, preferable first to apply the functional layer onto the band and then to form the structure directly by ablation. This situation obviates the winding after application of the functional layer, since the application and structuring are carried out in one working step.

According to the invention, the laser ablation takes place in a continuous step. To this end, the support layer formed as a transparent band with an absorption layer applied thereon, which has been coated with the functional layer, is penetrated by a laser beam which is focused onto the absorption layer. The absorption layer is preferably optimized for the laser being used. After having passed through the transparent support band, the laser beam is converted directly into heat in the absorption layer optimized for the laser, without the laser beam first having to penetrate through the functional layer.

This type of laser structuring has the advantage that the functional layer does not need to be adapted for the laser beam being used. Virtually any materials may be used for the functional layer. In principle, the laser also does not need to be adapted to the functional layer so that more cost-effective laser units can be used.

Furthermore, exposure from behind, i.e. through the support layer, contributes to increasing the process rate since the laser ablation is transported away from the laser and does not therefore lead to any optical interference, as is the case with the known lithography methods. In principle, for certain applications it is advantageous to provide a suction instrument or a blower instrument with the aid of which the laser ablation can be removed. The laser ablation may of course be removed in another way. For example, it is possible to use a solvent for cleaning.

At this point, it should be mentioned that the absorption layer may also be obviated according to the invention, in which case the functional layer itself must be absorbent.

It has been found that in many cases, the laser ablation can take place even more effectively when the functional layer and/or the absorption layer contains solvent. The proportion of solvent in the functional layer and/or the absorption layer preferably lies in the range of between 1 and 70 wt. %. The abrupt evaporation of the solvent due to the energy transfer assists the laser ablation.

The solvent may, for example, be supplied to the relevant layer before the energy transfer. In cases in which the functional layer and optionally the absorption layer have been applied onto the support layer with the aid of solvent, the energy transfer step may also be carried out before the solvent has fully evaporated from the layer composite.

Other advantages, features and possible applications will become clear from the following description of a preferred embodiment and the associated figures.

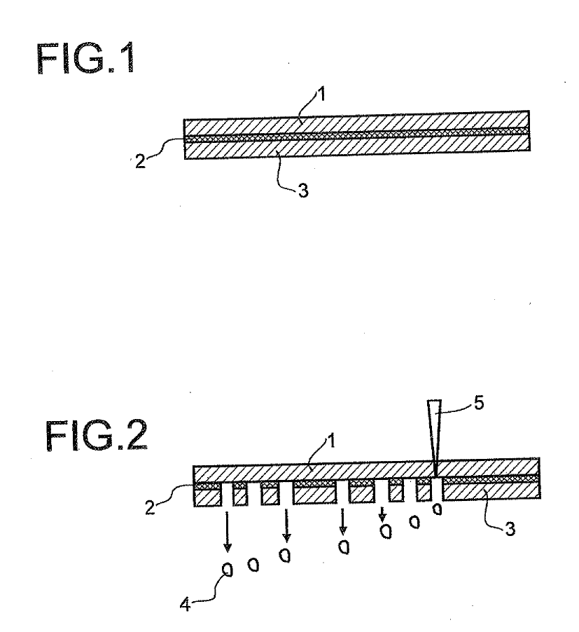

FIG. 1 shows the schematic layer construction,

FIG. 2 shows a schematic representation of the method according to the invention, and

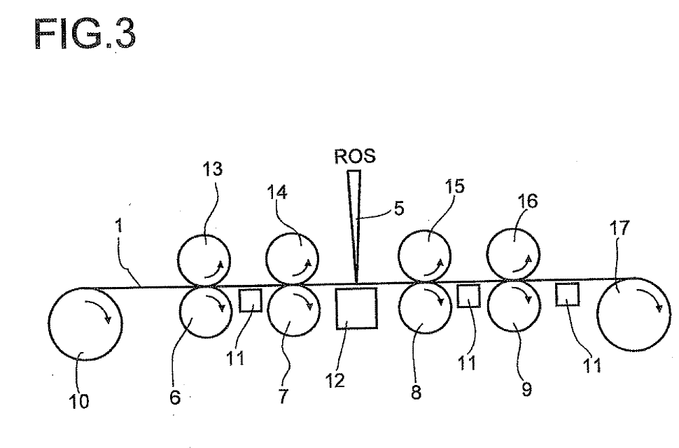

FIG. 3 shows a schematic representation of a preferred embodiment of the method according to the invention.

FIG. 1 shows a schematic representation of the layer construction before the structuring.

On a support layer 1, which may for example be formed as a transparent band that can be unwound from a roll, an absorption layer 2 is applied. The absorption layer 2 contains at least one substrate which absorbs incident laser light and converts it into heat. On the absorption layer 2, a functional layer 3 is applied. The functional layer 3 preferably contains electrically conductive materials, for example conductive polymers. According to the invention, the absorption layer 2 and the functional layer 3 are applied onto the support layer 1 in a first step. The absorption layer and the support layer are applied, for example, by a printing method known to the person skilled in the art.

FIG. 2 shows a schematic representation of the ablation process

A laser beam 5 which is controlled for example using an ROS (raster output scanner) unit, not represented here, is focused through the support layer 1 onto the absorption layer 2. The absorption layer 2 absorbs the laser light of the laser beam 5 and converts its energy into heat. In this way, the absorption layer 2 is heated so that it evaporates. The functional layer 3 applied on the absorption layer 2 is thereby co-ablated. Those parts of the absorption layer 2 and the functional layer 3 which are removed as laser ablation 4 from the support layer 1 move away from the support layer 1. Since the laser beam 5 is focused through the support layer 1 onto the absorption layer 2, the laser ablation 4, which essentially moves in the same direction as that in which the laser beam 5 points, does not interfere with the optical path of the laser beam 5.

FIG. 3 schematically represents a preferred embodiment of the method according to the invention.

The method according to the invention is preferably carried out in a device which combines a plurality of process steps. To this end the support layer 1, which is configured as a transparent band, is moved continuously from a roll 10 through the device. In the embodiment represented here, the support layer 1 formed as a transparent band is sent through a first coating unit, which comprises a printing roll 6 and a pressure roll 13. The material for the absorption layer is applied onto the printing roll 6. This is transferred onto the support layer 1, as soon as the support layer 1 is fed through between the printing roll 6 and the pressure roll 13. With the aid of the pressure roll 13, the support layer 1 is pressed against the printing roll 6.

In a first drying unit 11, which follows on from the first coating unit, the absorption layer 2 is dried.

In a second coating unit, which comprises a second printing roll 7 and a second pressure roll 14, the functional layer 3 is applied onto the absorption layer 2. The functionality of the second coating unit corresponds to the functionality of the first coating unit. Instead of the printing rollers 6, 7, against which the support layer I or absorption layer 2 to be coated is pressed with the aid of the pressure roll 13, 14, any other printing device known to the person skilled in the art may be provided for applying the absorption layer 2 and the functional layer 3. For example, the absorption layer 2 and the functional layer 3 may also be applied with the aid of screen printing methods, indirect or direct intaglio methods, flexographic printing, typography, pad printing, inkjet printing or any other printing method known to the person skilled in the art.

The second coating unit may be followed by a further drying unit, which is not represented here. In this second drying unit, the functional layer is dried.

The support layer 1 coated with the absorption layer 2 and the functional layer 3 is now sent to the actual laser ablation. The laser ablation comprises a laser source, not represented here, from which the laser beam 5 is delivered. The laser source furthermore comprises a laser switching and deflection unit (ROS). A suction instrument 12 is furthermore provided, by which the laser ablation 4 can be suctioned.

With the aid of the laser beam 5, those regions of the functional layer which are intended to be excavated are selectively removed from the support layer 1 together with the absorption layer 2, as represented in FIG. 2. The layer composite structured in this way, comprising the support layer 1, the absorption layer 2 and the functional layer 3, may subsequently be printed on again or provided with further layers, for example with the aid of other coating units which respectively comprise a printing roll 8, 9 with a corresponding pressure roll 15, 16. The coating units may respectively be followed by a further drying unit 11. Instead of the coating units which respectively comprise a printing roll 8, 9 and a pressure roll 15, 16, it is also possible here to use any other coating device known to the person skilled in the art. As an alternative, it is also possible to obviate the other coating units, comprising the printing rolls 8, 9 and pressure rolls 15, 16. Such is the case particularly whenever no further layers are intended to be applied after the ablation step.

After the structure has been excavated from the functional layer 3 with the aid of the laser beam 5 and the layer composite is optionally provided with further layers in the other coating units, it is wound up on a roll 17. In the form of this roll, the layer composite can be transported to further processing stations.

### LIST OF REFERENCES NUMERALS

1 support layer

2 absorption layer

3 functional layer

4 laser ablation

5 laser beam

6, 7, 8, 9 printing roll

10 roll

11 drying unit

12 suction instrument

13, 14, 15, 16 pressure roll

17 roll

1-13. (canceled)

14. A method for transferring structural information into a functional layer, comprising conductive polymers, an organic semiconductor material or a dielectric, the functional layer being provided on a support layer in a first step and energy being transferred in sections through the support layer into the functional layer in a second step, so as to cause a modification of the physical and/or chemical properties of the functional layer in the region of this zone, wherein the energy is transferred through the support layer into an absorption layer containing an absorbent for the laser being used and a binder, wherein the absorption layer lies between the support layer and the functional layer, and the energy is transferred from the absorption layer into the functional layer wherein the energy transfer is selected so that the absorption layer is fully removed in sections.

15. The method as claimed in claim 14, wherein the energy is transferred with the aid of a laser beam, which preferably has a wavelength of between 150 and 3000 nm.

16. The method as claimed in claim 14, wherein energy is transferred with the aid of an electron beam.

17. The method as claimed in claim 14, wherein the structural image represents an electronic circuit or parts thereof.

18. The method as claimed in claim 14, wherein at least two separate functional layers are provided.

19. The method as claimed in claim 14, wherein at least two absorption layers are provided, the two absorption layers preferably having different absorption spectra from one another and the energy being transferred with the aid of light beams with different wavelengths.

20. The method as claimed in claim 14, wherein the functional layer is cleaned after the energy transfer step.

21. The method as claimed in claim 20, wherein the ablation removed from the functional layer is suctioned or blown away or the functional layer is cleaned with the aid of a solvent.

22. The method as claimed in claim 14, wherein solvent is fed to the absorption layer and/or the functional layer before the energy transfer step.

23. A device for transferring structural information into a functional layer (3), having a feed instrument for feeding a support layer (1) provided with the functional layer (3) and an instrument delivering energy, which is designed so that energy can be transferred locally into the functional layer (3), wherein the instrument delivering energy is arranged so that the energy can be delivered through the support layer (1) into the functional layer (3), wherein the feed instrument for feeding a support layer (1) provided with a functional layer (3) comprises a feed for the support layer (1) and an instrument for applying the functional layer (3) and optionally the absorption layer (2), wherein the instrument for applying the functional layer (3) and optionally the absorption layer (2) comprises a printing roller (6, 7) and a pressure roller (13, 14).

24. The device as claimed in claim 23, wherein a laser (5) is provided as the instrument delivering energy.

25. The device as claimed in claim 23, wherein a plurality of lasers are provided, the laser wavelengths of which are different. 26, (New) The device as claimed in claim 23, wherein a suction and/or blower device (12) is provided for suctioning and/or blowing away the material ablated from the functional layer (3) and/or absorption layer (2).
